(19) United States
(12) Patent Application Publication
(10) Pub. No.: US 2025/0251089 A1
(43) Pub. Date: Aug. 7, 2025

(54) METHOD AND DEVICE FOR TRANSFERRING CRYOGENIC FLUID

(71) Applicant: L'Air Liquide, Societe Anonyme pour l'Etude et l’Exploitation des Procedes Georges Claude, Paris (FR)

(72) Inventor: Laurent ALLIDIERES, Paris (FR)

(21) Appl. No.: 19/045,194

(22) Filed: Feb. 4, 2025

(30) Foreign Application Priority Data
Feb. 7, 2024 (FR) FR 2401183

(51) Int. Cl. F17C 9/00; F17C 13/02

(52) U.S. Cl. CPC F17C 9/00; F17C 13/023; F17C 13/025; F17C 13/026; F17C 2221/012; F17C 2223/0161; F17C 2223/033; F17C 2227/0107; F17C 2250/043; F17C 2250/0439; F17C 2250/0443

(57) ABSTRACT

The invention relates to a method and a device for transferring liquefied cryogenic fluid, for example liquid hydrogen, from a cryogenic tank containing liquefied cryogenic fluid having a gas phase in equilibrium with the liquid phase, the transfer of fluid to a receiver being realized at least in part by way of a pressure difference between the cryogenic tank and the fluid receiver, the method comprising a step of pressurizing the fluid contained in the cryogenic tank, a step of withdrawing liquid from the pressurized cryogenic tank, a step of measuring the volume flow rate of withdrawn fluid, a step of determining the mass of withdrawn liquid from the measured volume flow rate of withdrawn fluid and the density of the withdrawn fluid, the density of the withdrawn fluid being determined from the pressure of the fluid in the cryogenic tank measured before the pressurization step.

### CROSS REFERENCE TO RELATED APPLICATIONS

This application claims the benefit of priority under 35 U.S.C. § 119 (a) and (b) to French patent application No. FR2401183, filed Feb. 7, 2024, which is herein incorporated by reference in its entirety.

### FIELD OF THE INVENTION

The invention relates to a method and a device for transferring cryogenic fluid.

### BACKGROUND OF THE INVENTION

The measurement of a liquid hydrogen flow rate encounters a number of difficulties. Flowmeters that are currently used, of the turbine type, give a volume flow rate value while the invoicing of the amount of liquid is based on a mass. Mass flowmeters of the Coriolis type are more expensive and difficult to put in place in a vacuum chamber. In addition, the mass flow rate reading they provide can be disturbed by the presence of bubbles in the liquid.

An aim of the present invention is to overcome all or some of the drawbacks of the prior art that are set out above.

### SUMMARY OF THE INVENTION

In certain embodiments, the invention relates more particularly to a method for transferring liquefied cryogenic fluid, for example liquid hydrogen, from a cryogenic tank containing liquefied cryogenic fluid having a gas phase in equilibrium with the liquid phase, the transfer of fluid to a receiver being realized at least in part by way of a pressure difference between the tank and the fluid receiver, the method comprising a step of pressurizing the fluid contained in the tank, a step of withdrawing liquid from the pressurized tank, a step of measuring the volume flow rate of withdrawn fluid, a step of determining the mass of withdrawn liquid from the measured volume flow rate of withdrawn fluid and the density of the withdrawn fluid.

In an effort to overcome the deficiencies of the prior art discussed, supra, the method according to the invention, which is otherwise in accordance with the generic definition thereof given in the above preamble, is configured such that the density of the withdrawn fluid is determined from the pressure of the fluid in the tank measured before the pressurization step.

Furthermore, embodiments of the invention may have one or more of the following features:
the method involves a step of measuring the pressure of the fluid in the tank, a step of detecting an increase in pressure corresponding to a pressurization step, the pressure of the fluid in the tank measured before the pressurization step being a pressure value measured before the detected increase in pressure,
the density of the withdrawn fluid is calculated from the following formula: D=−2.36P+72.8 (D being the density in kg/m3 and P the pressure in bar abs) and/or from a determined table giving the density of the fluid as a function of its pressure,
the step of determining the mass of withdrawn liquid comprises calculating said mass by multiplying the density by the value of the measured volume flow rate of withdrawn fluid,
the step of determining the mass of withdrawn liquid comprises a step of correcting, for example by a multiplying coefficient, the value of the measured volume flow rate,
the step of measuring the volume flow rate of withdrawn fluid is realized with a flowmeter of the volumetric type.

In certain embodiments, the invention also relates to a device for transferring liquefied cryogenic fluid, for example liquid hydrogen, comprising a cryogenic tank intended to contain liquefied cryogenic fluid having a gas phase in equilibrium with the liquid phase, a liquid transfer duct having an upstream end connected to the tank and a downstream end intended to be connected to a receiver, the liquid transfer duct comprising a volumetric flowmeter, the device comprising a system for pressurizing the fluid contained in the tank, a pressure sensor for the fluid in the tank, a temperature sensor, an electronic data storage and processing component comprising a microprocessor, the electronic component being configured to determine the density of the fluid withdrawn by the transfer duct from the pressure value of the fluid measured by the pressure sensor.

The invention may also relate to any alternative device or method comprising any combination of the features above or below within the scope of the claims.

Further particular features and advantages will become apparent upon reading the following description, which is provided with reference to the figures, in which:

### BRIEF DESCRIPTION OF THE DRAWINGS

The invention will be understood better from reading the following description and from studying the accompanying FIGURES. These FIGURES are given only by way of illustration and do not in any way limit the invention.

The FIGURE is a schematic and partial view illustrating an example of the structure and operation of a tank implementing the invention.

### DETAILED DESCRIPTION OF THE INVENTION

Throughout the FIGURE(S), the same references relate to the same elements.

In this detailed description, the following embodiments are examples. Although the description refers to one or more embodiments, this does not mean that the features apply only to a single embodiment. Individual features of different embodiments can also be combined and/or interchanged to provide other embodiments.

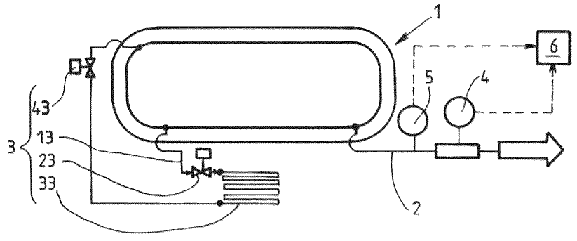

FIG. 1 illustrates an example of a device for transferring liquefied cryogenic fluid that can implement the invention.

The device comprises a cryogenic tank 1 intended to contain liquefied cryogenic fluid having a gas phase in equilibrium with the liquid phase (hydrogen, for example). The tank 1 is preferably a double-shell tank comprising a thermally insulated space (preferably under vacuum) between the shells.

The device comprises a liquid transfer duct 2 having an upstream end connected to the tank 1 and a downstream end intended to be connected to a receiver of the withdrawn fluid.

The liquid transfer duct 2 comprises a volumetric flowmeter 4.

The device comprises a system 3 for pressurizing the fluid contained in the tank 1.

This pressurization device 3 comprises or is constituted, for example, of a pressure generating unit (PBU, pressure building unit). This pressurization device 3 comprises, for example, a pressurization duct 13 connected in a loop to the tank (a first end connected, for example, to the lower part of the tank 1 and a second end connected, for example, to the upper part of the tank. Between these two ends, the pressurization duct 13 comprises a heating exchanger 33 (in heat exchange, for example, with air) and a set of one or more valves, for example two valves 13, 43 situated on either side of the heating exchanger 33.

The transfer of liquid from the tank 1 (which is mobile or fixed) to a receiver is realized at least in part by way of a pressure difference. To this end, the tank 1 can be pressurized in order to effect this transfer. The pressurization from the tank 1 at thermodynamic equilibrium can be realized conventionally by withdrawing liquid from the tank via the opening of the valve 13 upstream of the heating exchanger 33, vaporizing this liquid in the heating exchanger 33, then returning the hot gas obtained by natural convection to the gas headspace of the tank via the opening of the valve 43 downstream of the heating exchanger 33.

This pressurization method increases the gauge pressure of the fluid by a determined value (typically of the order of 0.2 to 3 bar). This increase in pressure does not significantly increase the temperature of the liquid in the tank. This means that the fluid in the tank 1 passes from the saturated state to a subcooled liquid state.

Once the liquid has been pressurized, the liquid is decanted by way of a pressure difference to the receiver (opening of one or more appropriate valves in the transfer duct 2).

For invoicing purposes, a measurement of the (volume) flow rate 4 withdrawn is effected. Since invoicing has to be done with a mass measurement, a correction in terms of density of the read volume value is necessary.

Since the density of the liquid depends on its saturation pressure, the measurement of volume flow rate (with a turbine flowmeter, for example) is not possible without correction of the density value.

The device comprises a pressure sensor 5 for the fluid in the tank 1, which is situated for example on the transfer duct 2, upstream of the flowmeter 4.

The indication of the pressure of the fluid at the time of withdrawal does not allow reliable correction because the liquid is not in thermodynamic equilibrium.

According to one advantageous particular feature, the pressure in the tank is measured or determined when there is equilibrium between the gas phase and the liquid phase. The increase in gauge pressure caused by pressurization is detected, during the activation of the pressurization system 3, and/or by detection of a sudden rise in pressure that is significantly faster than the rise in pressure of the tank that is linked to the thermal inputs (of multiple bars per hour for pressurization by PBU vs 15 mbar/h). The pressure sensor 5 can thus detect an increase in the pressure linked to a pressurization by detecting, for example, a break (discontinuity, for example) in the measured pressure gradient. This value of gauge pressure just before the start of the rise in pressure can be retrieved (recorded, for example) for example by using the value at a time that is temporally offset with respect to the rise in pressure.

This pressure value makes it possible to calculate or determine, with the aid of a chart, the density of the liquid that is withdrawn.

The density is obtained, for example, via a calculation and a formula D=−2.36×P+72.8 (D being the density in kg/m3 and P the pressure in bar abs) and/or via a predetermined lookup table or tabulation such as that below:

TABLE 1

| | Density of the liquid |
|---|---|
| Pressure (MPa) | (in kg/m³) |
| 0.10000 | 70.899 |
| 0.20000 | 67.712 |
| 0.30000 | 65.189 |
| 0.40000 | 62.949 |
| 0.50000 | 60.847 |
| 0.60000 | 58.800 |
| 0.70000 | 56.748 |
| 0.80000 | 54.632 |
| 0.90000 | 52.381 |
| 1.0000 | 49.888 |
| 1.1000 | 46.942 |
| 1.2000 | 42.960 |

This density value makes it possible to correct the volume flow rate value read by the flowmeter 4.

To this end, the device 1 may comprise an electronic data storage and processing component 6 with one or more microprocessors. This electronic component 6 can be configured to determine the density of the fluid withdrawn by the transfer duct 2 from the pressure value of the fluid measured by the pressure sensor 5.

In the case in which the tank 1 is mobile, during a round with multiple deliveries, the energy injected during the delivery so as to pressurize the tank and the transport between two delivery points increase the temperature of the liquid (and therefore the saturated pressure for a system in equilibrium).

The invention makes it possible to determine the density of the liquid at the time of delivery, which is not correlated with the gauge pressure during withdrawal.

The invention makes it possible to correct, in terms of density, the measurement of a volumetric flowmeter during a cryogenic liquid delivery.

The determination of the mass of withdrawn liquid may comprise calculating said mass by multiplying the density by the value of the measured volume flow rate of withdrawn fluid.

This makes it possible to determine an amount by mass of transferred liquid. This is made possible even if the gauge pressure during this delivery is de-correlated from the density of the delivered fluid (the liquid being subcooled).

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

1. A method for transferring a liquefied cryogenic fluid from a cryogenic tank containing the liquefied cryogenic fluid having a gas phase in equilibrium with the liquid phase, the transfer of liquefied cryogenic fluid to a receiver being realized at least in part by way of a pressure difference between the cryogenic tank and the receiver, the method comprising the steps of:
measuring a first pressure within the cryogenic tank;
pressurizing the liquefied cryogenic fluid contained in the cryogenic tank;
withdrawing liquid from the pressurized cryogenic tank;
measuring a volume flow rate of withdrawn liquid from the pressurized cryogenic tank; and
determining a mass of withdrawn liquid from the measured volume flow rate of withdrawn fluid and the density of the withdrawn fluid,
wherein the density of the withdrawn fluid is determined from the first pressure.

2. The method according to claim 1, further comprising following the pressurizing step, measuring a second pressure of the liquefied cryogenic fluid in the cryogenic tank.

3. The method according to claim 1, wherein the density of the withdrawn fluid is calculated from the following formula: D=−2.36P+72.8 and/or from a determined table giving the density of the fluid as a function of its pressure, wherein D is the density in kg/m3 and P is the pressure in bar abs.

4. The method according to claim 1, wherein the step of determining the mass of withdrawn liquid comprises calculating said mass by multiplying the density by the value of the measured volume flow rate of withdrawn fluid.

5. The method according to claim 1, wherein the step of determining the mass of withdrawn liquid comprises a step of correcting the value of the measured volume flow rate.

6. The method according to claim 5, wherein the step of the value of the measured flow rate comprises using a multiplying coefficient.

7. The method according to claim 1, wherein the step of measuring the volume flow rate of withdrawn fluid is realized with a volumetric flowmeter.

8. The method according to claim 1, wherein the liquefied cryogenic fluid is liquid hydrogen.

9. A device for transferring a liquefied cryogenic fluid, the device comprising:
a cryogenic tank configured to contain the liquefied cryogenic fluid having a gas phase in equilibrium with a liquid phase;
a liquid transfer duct having an upstream end connected to the cryogenic tank and a downstream end configured to be connected to a receiver, the liquid transfer duct comprising a volumetric flowmeter;
a pressurizing system configured to pressurize the liquefied cryogenic fluid contained in the cryogenic tank before withdrawal;
a pressure sensor configured to measure the pressure within the cryogenic tank;
a temperature sensor; and
an electronic data storage and processing component comprising a microprocessor, the electronic data storage and processing component being configured to determine a density of the liquefied cryogenic fluid withdrawn by the transfer duct from a pressure value from the pressure sensor prior to the pressurizing system pressurizing the liquefied cryogenic fluid.
